(19) United States
(12) Patent Application Publication
(10) Pub. No.: US 2006/0208857 A1
(43) Pub. Date: Sep. 21, 2006

(54) Use of rfid tags and readers to automate real time alert signals in a security system

(76) Inventor: Kai En Wong, Singapore (SG)

Correspondence Address: LAWRENCE Y.D. HO & ASSOCIATES PTE LTD, 30 BIDEFORD ROAD, #07-01, THONGSIA BUILDING, SINGAPORE, 229922, SG

(21) Appl. No.: 10/564,289

(22) PCT Filed: Jun. 17, 2004
(86) PCT No.: PCT/SG04/00184

§ 371 Date: Jan. 11, 2006

(30) Foreign Application Priority Data
Jul. 31, 2003 (SG) 200304267.8

(51) Int. Cl. G05B 19/00; F41A 17/00; G08B 1/08

(52) U.S. Cl. 340/5.82; 340/539.13; 42/70.01

(57) ABSTRACT

A security system for automatically transmitting alert signals when a security appliance such as a firearm (110) carried by a security officer is drawn from its holster (130), and the method of enabling such a function under the present invention is described. The present invention makes use of radio frequency identification tags (eg 120, 134) and readers (eg 136, 186) to trigger these automatic alerts. The present invention also uses s locator function associated with a mobile device to automatically direct aid to the officer in danger. The present invention also encompasses a method of conducting security guard patrols that monitors the progress of the security guard in real time as he logs each checkpoint of the tour, through the use of RFID tags and readers.

### FIELD OF THE INVENTION

The present invention relates to the use of radio frequency identification (RFID) tags.

In particular, this invention relates to a security system wherein REFID tags, RFID tag readers and transceivers are used to automatically generate a security alert whenever a security appliance, such as a firearm is withdrawn from its holster.

The invention also relates to a security system wherein combinations of signals generated by the use of RFID tags in security appliances are used to monitor the activity of security personnel and to determine the real time status.

### BACKGROUND OF THE INVENTION

A brief background of how RFID tags work is now given. RFID tags work as transponders in telecommunications systems, responding and transmitting information to a query or poll sent by a reader device or transceiver. The query signal is carried on an electromagnetic wave which is reflected from the RFID tag. The RFID tag modifies this reflected wave to carry its reply signal back to the reader device. RFID tags have been used to keep track of library books, to prevent loss of high-value goods from shops, and to monitor movement of cargo containers.

To respond and transmit, RFID tags can be powered by an internal electrical source; such tags are known as active tags. Alternatively, another type of RFID tags do not have their own power source and instead derive energy to respond from the electromagnetic query wave itself. Such RFID tags are called passive tags. As they themselves do not have their own power source, passive tags usually have a much shorter operational range (less than one meter) compared to active tags.

At present, several security features involving RFID tags have been developed for use in firearms, all of such features work to prevent the unauthorized use of these firearms. Examples are inventions using passive RFID tags embedded in finger rings worn by authorized security personnel. Such tags enable the use of a modified, or specially made, firearm or weapon.

The objective behind such products is that, if the firearm is forcibly taken from the officer, it will be out of range of the RFID tag worn by the officer and this out-of-range situation will disable the firearm. Unfortunately, these snatched firearms can still be used against the officers themselves if an assailant wrestles the firearm away and turns the firearm against the officer while within the transmission range of the RFID tag.

When such situations occur, the officer's higher authority or supervisor may not know of the incident until much later, after which the criminal may have fled and the officer injured or killed.

RFID tags have also been used in security systems such as security guard patrol tour systems. In such systems, a security guard patrolling an area logs in each check point in his tour by bringing a reader device into close proximity with RFID tags at each fixed check point. The RFID tag then responds to the poll by the reader signifying that the security guard is indeed at the checkpoint.

The transceiver in this application may have a logging capability to record the RFID points visited together with other information such as time stamps. With such systems, confirmation of the guard's tour of the area is only made after the transceiver is connected to the supervisor's computer and the logged information downloaded. A supervisor who wishes to check on the location of the guard has to contact the guard by another communications means such as mobile telephone or two-way radio (“walkie-talkie”) to ask for his current location.

Such security systems have several deficiencies. Firstly, logging of the tour by the supervisor's computer is not done in real time. Secondly, any life threatening or emergency situation encountered by the security guard has to be reported by the separate radio or telephone communications means. If the guard is surprised, disabled or rendered unconscious by criminals, knowledge of the attack may not be known until hours later when the guard did not check in during routine reporting.

Therefore, a need clearly exists for an invention that addresses the above deficiencies in ignorance of firearm use or in security guard tours, by automatic notification of life threatening or emergency situations. Such an invention would be welcome by the security industry.

### SUMMARY OF THE INVENTION

The present invention seeks to provide a radio frequency identification (RFID) based security system comprising:
at least one sub-system;
at least one check point with at least one RFID tag; and
at least one central computer with wireless communications means;
wherein
said at least one sub-system further comprises:
   at least one security appliance with at least one RFID tag;
   at least one reader device associated with said at least one
   security appliance; and at least one mobile device acting as a
   radio frequency link for said at least one security appliance
   and said at least one reader device.
Accordingly, the present invention also provides a method of monitoring status of a security appliance carried by a security officer through the use of RFID tags, said method comprising:
polling, at regular intervals, at least one RFID tag associated with said at least one security appliance, by at least one reader device;
sending a signal from at least one reader device to said at least one mobile device when a response is not received from said at least one RFID tag polled; and sending another signal from said at least one mobile device, thereby indicating status of said security appliance.

The present invention further provides a method of conducting a security guard patrol tour using RFID tags in a security system, said method comprising:
a. verification of identity of security guard at start of tour;
b. registering of said security guard, list of security appliances and mobile device;
c. monitoring continually status of said security appliances and mobile device;
d. monitoring continually location of said guard;
e. logging of each check point visited;
f. determining, in real time, if said logging is valid;
g. transmitting, by said mobile device, logged checkpoints and other information to a communications network of a security system;
h. updating of information pertaining to tour to mobile device by a higher authority; and
i. repeating Step c until end of said tour.

### BRIEF DESCRIPTION OF THE DRAWINGS

A preferred embodiment of the present invention will now be more fully described, by way of example, with reference to the drawings of which:

FIG. 1 is a functional diagram of showing some of the elements of a security system in accordance with the present invention;

FIG. 2 is a the arrangement of components of the present invention for several security appliances; and

FIG. 3 is a an example of part of a security system of the present invention providing automatic real time alerts from, activity monitoring and location of security personnel in accordance with the present invention.

### DETAILED DESCRIPTION OF THE DRAWINGS

A detailed description of the invention will now be given in accordance with a preferred embodiment of the invention are described. In the following description, details are provided to describe the preferred embodiment. It shall be apparent to one skilled in the art, however, that the invention may be practiced without such details. Some of these details may not be described at length so as not to obscure the invention.

It is an object of the present invention to use RFID tags and readers to provide an automatic means of alert when a security appliance such as a firearm is drawn, indicating a potentially life-threatening situation.

It is another objective of the present invention to use RFID tags and readers to provide an automatic means of monitoring the activity or status of security personnel.

It is yet another object of the present invention to provide a security system using RFID tags and readers to monitor use of security appliances and for monitoring the status and activity of security personnel.

There are many advantages of the preferred embodiment of the invention. One advantage of the preferred embodiment is that, when security personnel encounter life-threatening situations, the combination of signals from the RFID tags embedded in their security appliances will automatically cause an alert signal to be broadcast. Aid can be then rushed to the location without requiring any further input such as voice requests from the personnel involved. The officer can concentrate on the dealing with the threat and have confidence that aid has already been summoned.

Another advantage of the present invention is that real time logging, verification and notification of checkpoints in a security guard's tour can be done automatically through RFID tags embedded in the security appliances worn by the guards and in the RFID tags fixed at the checkpoints. Should the security guard be rendered unconscious and is immobile for a predetermined length of time, the combination of signals from the RFID tags, together with other elements of the present invention, will cause an alert signal to be sent to the guard's supervisor.

The arrangement of RFID tags and reader devices in the present invention advantageously allows flexibility in the system of the present invention where false alerts are minimized, safety of security personnel is enhanced, and vulnerability to fixed routines and circumvention of security precautions are minimized.

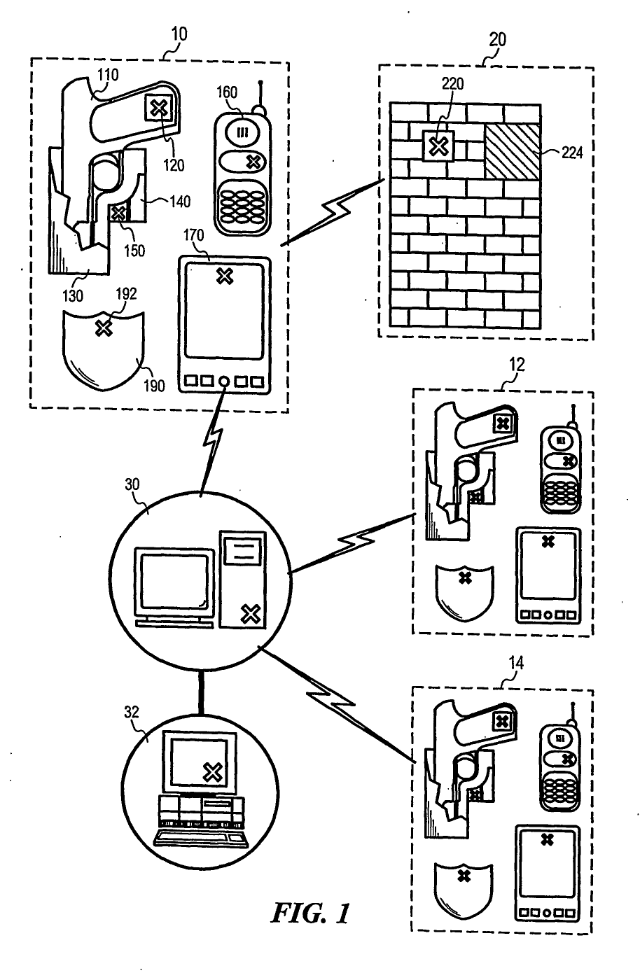

FIG. 1 is a functional diagram of showing the basic arrangement of some of the elements of a security system in accordance with the present invention.

A modular sub-system 10 is for a single security officer is shown and many sub-systems (eg 12, 14) may be linked in the system of the present invention. One of the elements in this sub-system is a security appliance such as a firearm 110 with at least one RFID tag 120 embedded in it, and its complementary holster 130 with at least one reader 140 associated with the security appliance in close proximity to the appliance or built into the holster. The holster itself may have another RFID tag 150.

Other examples of security appliances under the present invention include stun guns, incapacitating sprays (eg tear gas, pepper spray) and batons. A security appliance also includes any identification device (badge 190 or warrant card) worn or carried by the security officer that contains at least one RFID tag. A security appliance may also refer to a reader device. Again, a security appliance may also be an element that has both an RFID tag and reader device built into it such as the above-mentioned holster 130.

The next element of the security system of FIG. 1 is a multi-functional mobile device 170. The mobile wireless device has a host of capabilities including a biometric authenticator such as a finger printer or retina reader, location indicator, movement sensor, guard tour logger, duress (emergency or panic) alarm, and a digital still and movie camera. The mobile device also acts as a radio frequency (RF) link for the other RFID tags and readers associated with the security appliances and their complementary holsters carried by the officer.

Depending on the degree of sophistication desired, the mobile device may be capable of transmitting data or enabling voice communication with other security personnel and higher authority. It will be appreciated by anyone skilled in the art that, for this purpose, the mobile device and the system of the present invention may be implemented using the General Packet Radio System (GPRS) under a GSM (Global System for Mobile Communications) network or any other suitable network or communications means such as the CDMA (Code Division Multiple Access) system

In addition, another mobile communication device 160 such as a mobile phone or a two-way radio, may be part of the security sub-system 10. An individual sub-system 10 worn by a single officer may be linked via one or more communication systems in a network with other sub-systems (eg 12, 14) worn by other security officers.

Other elements of the system shown in FIG. 1 are the RFID tags 220 embedded in each checkpoint 20 in a predetermined area. The modular sub-system 10 for each security officer and the checkpoint sub-systems 20 are linked via the RF capability of the mobile device 170 to the local area network of the central computer system 30 of the higher authority or supervisor. The central computer system 30 may be linked to other computer systems 32 in a network.

Any signal or communication sent voluntarily by the security personnel or automatically by the mobile device is captured by the communications system of the higher authority or supervisor and disseminated within the network. Depending on pre-determined rules, this information may be also captured by other sub-systems 12, 14, etc, carried by other officers in the vicinity. As the mobile device 170 has a location indicator capability using either a GSM system, the GPS (Global Positioning System), or both, the location of the officer in danger may be rapidly made known to the other officers. As GPS does not work indoors and the GSM locator triangulation resolution may not be sufficiently high, each check point 20 may also have dedicated access points 224 that broadcast location signals for this purpose.

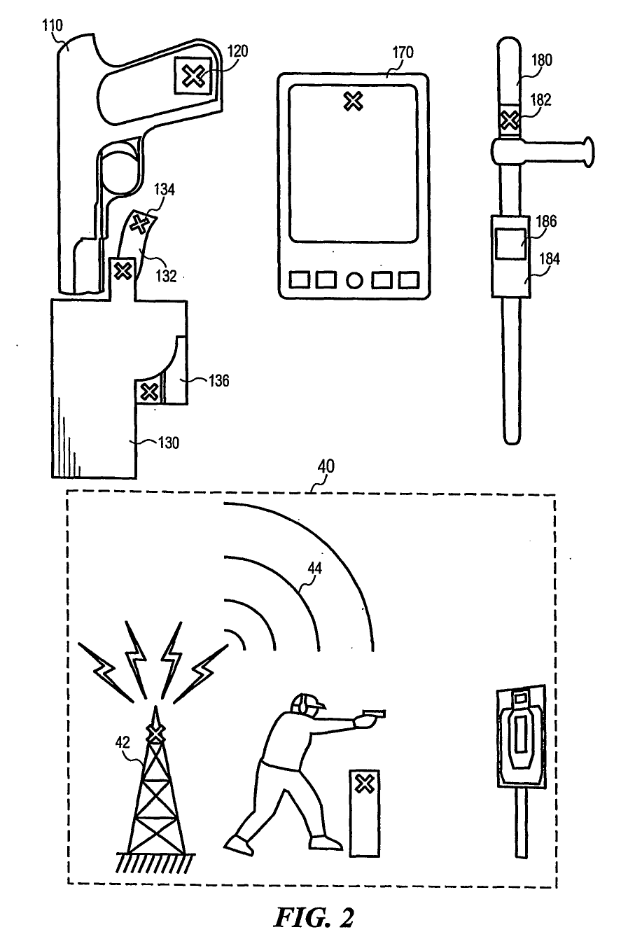

FIG. 2 illustrates how an alert signal is sent when a security appliance (in this case a firearm) is withdrawn from its holster. In a normal situation, say, when the officer is on patrol, the firearm 110 is held in its complementary holster 130. The firearm may be secured by one or more restraints. In FIG. 2, this restraint is a strap 132 with a “thumb break”arrangement. Other forms of restraints include rotating semi-rigid straps or hoods working in co-operation with a thumb break arrangement.

An RFID tag 120 is embedded in the firearm and another RFID tag 134 is associated with the strap. Both tags are polled at regular intervals (say once every 0.25 seconds or four times a second) by a reader device 136 built into the holster or attached to the officer's belt, in close proximity to the tags.

Another security appliance can be that of a baton 180 with its own RFID tag 182 in its complementary holster 184. The baton's holster has its own RFID reader 186.

In a normal situation where the firearm remains in the complementary holster, no alert signal is sent. However, in situations in which the officer has to draw his firearm, he has to first release the thumb break. This action moves the tag 134 associated with the strap out of the reader's range, signaling a potentially abnormal situation.

When the firearm is withdrawn from the holster, the tag in the firearm 120 will be moved out of range of the reader 136. When the tags of the firearm and strap do not respond to the reader's polling, the reader will relay a signal to the mobile device 170 which in turn will broadcast an alert signal. In other words, the mobile device 170 acts as a wireless, radio frequency (RF) link or relay for the reader to another wireless communications device.

In the case when a baton 180 is withdrawn from its complementary holster 184, the displacement of the baton's RFID tag 182 out of range of the holster's RFID reader 186, will cause an alert signal to be sent.

Such alert or status signals are sent to the security officer's higher authority via a communications network and then to a central computer.

Thus, it can be seen that the use of the RFID tags and readers in the system of the present invention can be used to monitor or determine the status of the security appliance, and indirectly, the status (and well-being) of the security officer.

For such RFID tags to work, the operating characteristics of the tag must be carefully determined as the system must be able to discriminate the small range of displacement of the RFID tags (120,134) and 182 from their respective readers 136 and 186 that would indicate release of the restraint and withdrawal of the security appliance.

According to pre-determined rules set by the user, such signals can be used to not only alert higher authority but the security system may also alert other officers in the vicinity that a fellow officer has drawn his firearm. Such alerts may be programmed to originate directly from the affected officer's mobile device 170 or be disseminated from the security system's central computer.

Within the system, this event will be logged, noting the location of the officer in danger as well as other officers around him. When such alerts have been signaled, the system can also be programmed to track the movements of these affected officers at closer time intervals for debriefing and post-event analysis.

An officer facing a life-threatening situation in which he has to draw his weapon to defend himself is unlikely to be able to devote much attention to summoning aid by conventional means such as a verbal request over his two-way radio. Thus can be readily appreciated by others skilled in the art (in this case, security or police officers) that the present invention is advantageous in such situations. Under the present invention, help is not only automatically summoned by the combination of signals from the co-operation of the RFID tags in the firearm and the holster strap, with the readers in the holster and the mobile device, but help is also quickly directed to the location of the officer in need by the information sent from the mobile device.

To retrofit an RFID tag in a firearm or baton, a recess may simply be milled into the grip of the firearm or shaft of the baton to accommodate the tag. Epoxy or a suitable sealant is then used to secure and seal the cavity, preventing any tampering of the tag. Alternatively, such security appliances may be fabricated with the RFID tag embedded during the manufacturing process.

Other security appliances (stun guns, sprays or baton) may also be similarly and readily modified for this function of the security system of the present invention. If desired by the user, the system of the present invention may be programmed to send graded alerts when different security appliances are drawn with incapacitating sprays and batons at a low priority and firearms having the highest priority of alerts.

For the reader device in or near the complementary holster, the reader may be made to meet high standards of rugged use or even military use, suitably sealed from the elements and secured with tamper-proof fasteners.

The mobile device 170 may itself continually poll another RFID tag embedded with the holster or the holster's reader device. This allows a combination of signals to flexibly cater for a variety of situations in which alert signals should not be sent.

For example, when an officer returns the firearm to the armory at the end of his shift, the firearm may be removed from the holster without setting off an alert. Another example where an alert should not be broadcast is when the officer is practicing shooting at a range 40. Under such situations, predetermined “safe zones” may be created to prevent alert signals from being broadcast. Suppression of alert broadcasts may be achieved by a beacon 42 installed at the armory or range that “instructs” the mobile device that it is in a safe zone and that the withdrawal of the firearm is allowed. Alternatively, radio signals 44 at these safe zones can turn the mobile device off when the officer arrives and to turn the mobile device on again when the officer leaves.

It may also be appreciated that, in normal use, the system depends on continual broadcast of reassuring signals from the tags not to broadcast any alerts. Should the tags fail or are tampered with, alerts will be automatically broadcast as a precautionary measure making the present invention a “fail-secure” system.

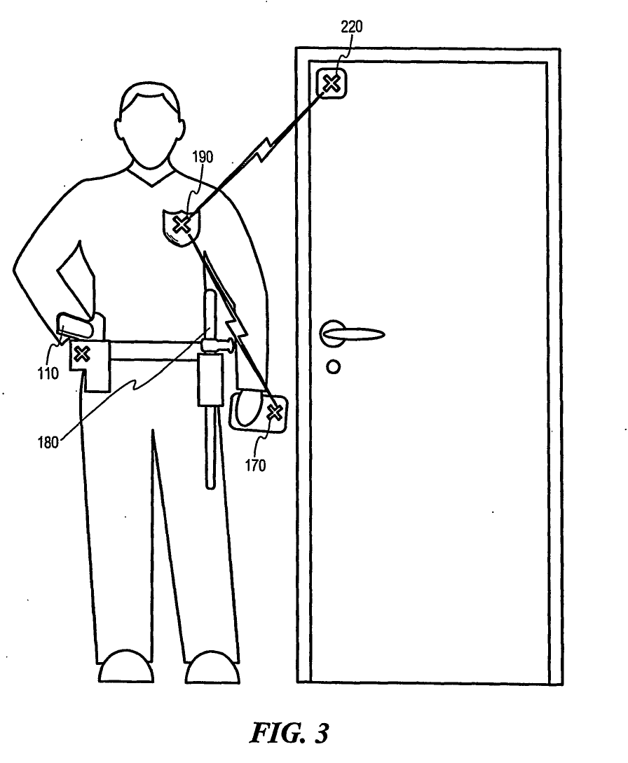

Other features of the present invention may be illustrated in another embodiment, that for use in a security guard patrol tour (FIG. 3).

At the start of his shift, the security guard has to verify and authenticate his identity. This authentication may be done using a combination of the security appliances with unique RFID tag identities issued to him such as his identity card, badge 180, warrant card. A higher level of security may be implemented with an optional built-in biometric authentication function such as a fingerprint or retinal pattern reader in the mobile device.

He then registers or logs himself into the security system as an authorized user. The mobile device will then register the drawing of ammunition and the list of security devices such as a firearm 110 or baton 180 carried by the guard for that shift.

After an optional systems check, the guard can begin his tour. The mobile device contains the itinerary (or sequence of check points) in which his supervisor wants him to patrol. An option exists for only one other checkpoint (the next checkpoint) to made known to the guard rather than the entire itinerary. Only after he reaches that checkpoint and logs in his visit will the following checkpoint be revealed to him.

For added security, each checkpoint can only be logged if both the guard's identity RFID tag 190 and the check point's RFID tag 220 is in close proximity to the reader in the mobile device 170. Again, the additional use of an optional biometric authenticator function with the mobile device will increase the level of security if desired.

The itinerary may be generated by the supervisor or in a pseudo-random pattern by the central computer system 30 (FIG. 1). Routes may be downloaded via wired or wireless means to the guard's mobile device.

Such a system has two obvious advantages. The first is the vulnerability offered by patrolling a fixed regular itinerary is eliminated. The second advantage is that any possible collusion between a security guard and criminal elements to avoid a particular checkpoint at a particular time is prevented.

As the itinerary can be downloaded wirelessly to the guard's mobile device 170, the itinerary can also be similarly updated “on the move” by the supervisor. This feature is advantageous if the supervisor wants the guard to increase frequency in a particular area where high-value goods are stored or where a very important person is present. Under the present invention, the mobile device may also house a digital camera. This capability will allow the guard to capture pictures as evidence on his own initiative or as directed by his supervisor. While in its complementary holster, the camera faces outwards and the supervisor can activate it remotely at anytime to verify the guard's location.

Another feature of the mobile device is a movement detector. The movement detector may be based on magnetometers sensing for the earth's magnetic field or accelerometers that detect movement. If little or no movement (below a certain set threshold) is detected for a predetermined length of time (say that longer for a typical toilet break), it could mean that the guard has been rendered unconscious, injured or killed (an “officer down” situation). In such cases, help can be directed to his location as known from GSM, access points and/or GPS triangulations. This feature also discourages a guard from loitering at any one location.

While data from the mobile device can be transmitted by wireless or mobile means to the supervisor's central computer, the mobile device also has a wired and wireless computer connectivity function to allow data, new parameters or upgraded software to be downloaded to as desired.

While the trend in the state of the art for security devices and systems has been to prevent the unauthorized use of a firearm, the present invention recognizes that this aim is fraught with the possibility of criminals circumventing such measures. Such measures can also be a liability when they malfunction and the firearm not enabled when the officer has to fire the weapon to defend himself or to prevent loss of another life.

Instead, the present invention points away from this trend of development. The present invention uses the cooperation of RFID tags and their readers to send alerts early in the course of a potentially life-threatening situation so that other officers may come to the aid of the officer in danger. This capability may help de-escalate the situation and save lives and property.

Another feature of the present invention is that such a security system reduces the need for human intervention when supervising security guards on patrol.

It will be appreciated that although only a few preferred embodiments have been described in detail, various modifications and improvements can be made by a person skilled in the art without departing from the scope of the present invention.

Also, while a handgun and its complementary holster have been described, the present invention may also be applied to other firearms that are not normally holstered when carried such as machine pistols, sub-machine guns, carbines, rifles and shotguns, as well as “less-lethal”firearms. Such firearms may be easily modified to trigger a signal from one RFID tag when its safety catch is disengaged and another signal sent from another RFID tag when the trigger is pulled.

Such variations of sending alert signals may also be extended to the charging of the weapon (making a round of ammunition ready to fire) by manual operation of the bolt. By putting an RFID tag on a part of the firearm that reciprocates on firing such as the bolt or bolt carrier and a reader device in the firearm just out of range of that tag, charging or firing the firearm will cause that tag to be brought close enough to the reader to send a signal.

Such embodiments of the present invention not only log the use of the weapon but can also count the number of rounds discharged. Such information may be potentially useful in the subsequent analysis of such events as evidence to determine if excessive use of force by security personnel has been used.

It may also be appreciated by one skilled in the art that the security system taught by the present application is exquisitely modular, allowing it to be scaled up to accommodate more sub-systems (officers and their security appliances). The system of the present invention can also be layered in a hierarchical structure wherein combinations of signals generated even by a single sub-system (10, FIG. 1) worn by an officer may be sent not only to his fellow officers and his supervisor, but also concurrently to higher authority in cases of extreme emergency according to predetermined rules.

1. A radio frequency identification (RFID) based security system comprising:
at least one sub-system;
at least one check point with at least one RFID tag; and
at least one central computer with wireless communications means;
wherein
said at least one sub-system further comprises:
at least one security appliance with at least one RFID tag;
at least one reader device associated with said at least one security appliance; and
at least one mobile device acting as a radio frequency link for said at least one security appliance and said at least one reader device.

2. A system according to claim 1, said at least one security appliance comprises a firearm, a baton, an incapacitating spray, a stun gun, a badge or a warrant card.

3. A system according to claim 1, said at least one reader device is placed in at least one complementary holster for said at least one security appliance.

4. A system according to claim 2, said at least one mobile device further comprises a locator function, a receiver function, a transmitter function, a movement detector function, a guard tour logging function, a duress alarm function, a digital camera function, a radio frequency link function, a computer connectivity function and a biometric authentication function.

5. A system according to claim 4 wherein at least one function of said at least one mobile device may be controlled remotely by a higher authority of said security officer.

6. A system according to claim 3 wherein said at least one reader device continually polls said at least one security appliance to determine status of said at least one security appliance and to indirectly determine status of security officer carrying said at least. one security appliance.

7. A system according to claim 6 wherein said status of said at least one security appliance is transmitted by said at least one mobile device to a communications network of said system.

8. A system according to claim 7 wherein said transmission of said status may be suppressed in predetermined safe zones.

9. A method of monitoring status of a security appliance carried by a security officer through the use of RFID tags, said method comprising:
polling, at regular intervals, at least one RFID tag associated with said at least one security appliance, by at least one reader device;
sending a signal from at least one reader device to said at least one mobile device when a response is not received from said at least one RFID tag polled; and
sending another signal from said at least one mobile device, thereby indicating status of said security appliance.

10. A method according to claim 9, said sending of another signal from said at least one mobile device further comprises sending of information to a central computer and at least one other mobile device.

11. A method according to claim 10, said information further comprises status and location of said security officer.

12. A method according to claim 9, said status further defined by combination of said signal from said at least one reader device and said another signal from said at least one mobile device.

13. A method of conducting a security guard patrol tour using RFID tags in a security system, said method comprising:
a. verification of identity of security guard at start of tour;
b. registering of said security guard, list of security appliances and mobile device;
c. monitoring continually status of said security appliances and mobile device;
d. monitoring continually location of said guard;
e. logging of each check point visited;
f. determining, in real time, if said logging is valid;
g. transmitting, by said mobile device, logged checkpoints and other information to a communications network of a security system;
h. updating of information pertaining to tour to mobile device by a higher authority; and
i. repeating Step c until end of said tour.

14. A method according to claim 13, said verification further comprises presentation of at least one security appliance with a unique RFID identity.

15. A method according to claim 14, said verification further comprises use of biometric authentication function of said mobile device.

16. A method according to claim 13, said monitoring of status of said security appliances further comprises polling of at least one RFID tag associated with said security appliances by at least one reader device in close proximity to said security appliances.

17. A method according to claim 16, said monitoring further comprises sending of alert signals when said at least one RFID tag does not respond to said polling by said at least one reader device.

18. A method according to claim 13, said monitoring of location of said security guard further comprises using a location function of said mobile device.

19. A method according to claim 18, said location function of said mobile device comprises capability to use make use of Global Positioning System, Global System for Mobile Communications, or dedicated access points within area of said guard tour.

20. A method according to claim 13, said determining in real time further comprises checking of each said logging, said checking further comprises verification of presence of a predetermined combination of security appliances carried by said guard and at least one RFID tag at said check point.

21. A method according to claim 13, said updating of information further comprises changes to tour itinerary and new instructions to said security guard.
